(19) United States
(12) Patent Application Publication
(10) Pub. No.: US 2015/0083837 A1
(43) Pub. Date: Mar. 26, 2015

(54) REGENERATION DEVICE

(71) Applicants: Technofond Giessereihilfsmittel GmbH, Harthausen (DE); DOMNICK VERFAHRENS- UND ANLAGENTECHNIK, Herdorf (DE)

(72) Inventors: Mark THIENEL, Harthausen (DE); Dietmar DOMNICK, Herdorf (DE)

(21) Appl. No.: 14/552,675

(22) Filed: Nov. 25, 2014

Related U.S. Application Data
(63) Continuation of application No. PCT/EP2013/001367, filed on May 8, 2013.

(30) Foreign Application Priority Data
May 25, 2012 (EP) 12004128.0

(51) Int. Cl. B02C 7/02; B02C 23/00

(52) U.S. Cl. CPC B02C 7/02; B02C 23/00
USPC 241/65

(57) ABSTRACT

A regeneration device configured for foundry sand reconditioning, having a cylindrical container having a cover and a bottom, wherein the container has a first opening and/or a second opening, and a plurality of rotationally driven friction elements formed in the container. The friction elements are arranged on a first shaft, and a first bearing is formed on the first shaft. The first shaft has a second bearing spaced apart from 1 he first bearing. The friction elements are arranged between the first bearing and the second bearing. The container has a first flange on the upper side and a second flange on the lower side, wherein the first flange is force-locked to the cover, and the second flange is force-locked to the bottom.

This nonprovisional application is a continuation of International Application No. PCT/EP2013/001367, which was filed on May 8, 2013, and which claims priority to European Patent Application No. 12004128.0, which was filed on May 25, 2012, and which are both herein incorporated by reference.

### BACKGROUND OF THE INVENTION

1. Field of the Invention

The invention relates to a regeneration device.

2. Description of the Background Art

EP 0 343 272 A1, which corresponds to U.S. Pat. No. 5,045,090, discloses a regeneration device and a method for reclaiming foundry sands. In this case, the sand is filled batch-wise into a container and mechanically reclaimed by means of friction elements.

### SUMMARY OF THE INVENTION

It is therefore an object of the invention to provide a device that refines the prior art.

According to an embodiment of the invention, a regeneration device is provided which is designed for reclaiming used foundry sand, whereby the regeneration device comprises a cylindrical container having a cover and a bottom and the container has a first opening and/or a second opening and a number of rotationally driven friction elements, formed in the container, are provided and the friction elements are arranged on a first shaft, and a first bearing formed on the first shaft is provided, and the first shaft has a second bearing, spaced apart from the first bearing, and the friction elements are arranged between the first bearing and the second bearing, and the container has a first flange on the upper side and a second flange on the lower side, whereby the first flange is force-locked to the cover and the second flange is force-locked to the bottom.

It is understood that the term, used foundry sand, can refer to sand that forms the casting molds for a cast metal. Main mixture parts of the used sand, apart from the quartz grains which can be classified in a specific grain size fraction, are in particular additives such as organic or inorganic binders and substances to increase thermal conductivity. Because of the addition of additives, the used sand cannot be reused in the foundry without reclaiming and must be taken to waste disposal. In addition to the considerable environmental burden for the transport of large amounts of sand, there are in addition high permanent disposal costs.

It should be noted that at least one opening can be provided on the container for filling the container with used sand and for removing the regenerated sand. The regenerated sand is also called regenerated material. For regeneration of the sand, during or after the filling of the container with used sand, the shaft is brought to a certain speed by, for example, an electric motor. Hereby, the friction elements arranged on the shaft perform circular movements and transmit part of the mechanical energy to the sand to be regenerated. Depending on the rotational speed of the shaft and the duration, the sand is heated thereby and kept suspended in the container. The sand is regenerated after a time interval and can be removed. In order to facilitate the handling, a first opening is [to be provided] on the container for supplying the used sand and a second opening, spaced apart from the first opening, for removing the regenerated material. An advantage of the formation of two openings is that the used sand can be fed into the container and the regenerated material removed from the container in a simple way without rotating the container. It has also turned out that the stability of the regeneration device can be greatly increased by the at least twofold support of the shaft.

A further advantage of the device of the invention is that the used sand can be regenerated almost completely. The degree of regeneration is above 60%, preferably above 85%, and most preferably above 95%. The degree of regeneration can be understood hereby as the weight ratio of the filled used sand to the regenerated material.

Tests have shown that a batch operation, i.e., supplying the entire amount of sand to be regenerated at the start of the processing and removing the amount of regenerated sand at the end of the processing, is especially advantageous and leads to the highest degree of regeneration. Particularly in the case of processing so-called inorganically bound sands, apart from degrees of regeneration above 95%, the quality of new sand is achieved after the processing of the used sand. It became evident that repeated processing also does not lead to any reductions in quality and the used sand can be processed as often as desired.

In an embodiment, the cover is connected by means of a first screw connection to the first flange and the bottom with a second screw connection to the second flange. In this way, the parts can be easily disassembled and the system can be inspected rapidly and cost-effectively. In particular, the friction elements arranged on the shaft and the shaft itself are subject to wear and should be replaced from time to time. In another refinement, the first bearing is flange-mounted on the upper side of the cover, preferably force-locked to the cover by means of screw connections.

According to an embodiment, the first opening can be formed as a filling device and/or as an exhaust opening and the second opening as an outlet device and/or as an air intake opening. Tests have shown that the quality of the regenerated material can be increased, when part of the fine dust formed during the reclaiming can be taken out via the exhaust opening. It is advantageous here to provide a third opening, spaced apart from the first opening and formed as an exhaust device, and/or a fourth exhaust opening, spaced apart from the second opening and formed as an air intake device. In particular, when in addition to the exhaust opening an air intake opening is also formed, an especially large amount of the accumulating fine dust can be removed from the sand.

In an embodiment, the bottom is formed as a distribution chamber, whereby the distribution chamber is separated off from the container by means of a distribution plate. It is advantageous to form the fourth opening, i.e., the air intake opening on the distribution chamber; in particular, it is advantageous to form the fourth opening on an underside of the bottom, preferably in the middle or in the vicinity of the middle of the bottom. It is furthermore advantageous, if the first opening and the second opening are formed directly on the container and have a connector-shaped formation on the outside of the container.

According to an embodiment, one or more temperature sensors are arranged on the container to determine the temperature of the sand. In a further refinement, hole-like recesses for receiving the temperature sensors are provided in the container walls. It turned out that for a rapid and reliable determination of the sand temperature during the regeneration process, it is advantageous to pass the temperature sensors through the container wall and to attach them to the inside of the container. In a further refinement, the sensors are fixed at different vertical positions on the container wall. Tests have shown that the quality of the reclaimed sand and the degree of regeneration depend, among others, on the duration of the regeneration and particularly on the run temperature/time profile during the regeneration, i.e., during the reclaimining. It is advantageous further to determine and possibly change the rotational speed of the shaft, for example, by means of a frequency converter. This allows for the temperature of the sand in the container to be both reduced and increased. In particular, it is advantageous to use a programmable control device to regulate the shaft rotational speed by controlling the electric motor based on the measured temperature of the sand and the duration. It has been shown that at a given filling volume and a given type of used sand a predetermined regeneration program can be run and by means of the control device the deviation can be determined by means of a target/actual comparison, particularly quantities such as temperature, time, and rotational speed, and the deviation can be reduced by changing the rotational speed. Furthermore, the control device can be connected both to a shutoff device formed on the first opening and to a shutoff device formed on the second opening, in order to enable automatic filling and emptying of the container. The quality of the regenerated material can be improved by the automation.

In a further embodiment, the second bearing can form a force-locking connection with the bottom. It is also advantageous, if the bottom has a first recess and the first recess receives the second bearing, so that the second bearing is arranged outside the outer side of the housing. As a result, the ease of system maintenance is increased. It turned out that because of the high mechanical forces to which the bearings are exposed, it is advantageous if the first bearing and the second bearing each have a grease nipple in order to be able to easily regrease the bearing.

In order to reduce the mechanical stress further, it is advantageous to orient the shaft parallel to the longitudinal axis of the cylinder. According to an alternative embodiment, a second shaft can be provided with second friction bars. Particularly for larger containers this assures uniform mixing and reclaiming. Specifically with large diameters, there is a large speed difference between the tangential ends on the friction elements and the regions near the shaft on the friction elements. This imposes high requirements on the balance and stability of the shafts. Because in the design with two or more shafts certain regions in the container are not swept by the friction elements, it is particularly advantageous for increasing the efficiency during the processing to provide a deflecting bar in the regions on the inner side of the container. As a result, the sand is again redirected to the middle of the container and a uniform quality is achieved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a cross section of an embodiment of the invention;

FIG. 2 shows a cross section of an embodiment of the invention; and

FIG. 3 shows a cross section of an embodiment of the invention.

### DETAILED DESCRIPTION

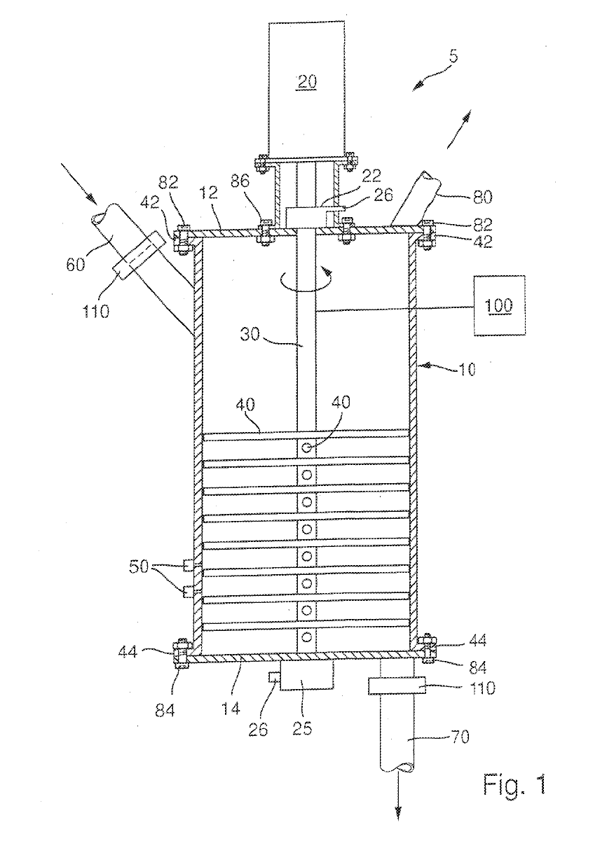

The illustration in FIG. 1 shows a schematic cross section of regeneration device 5 of the invention, designed for reclaiming old foundry sands, with a cylindrical container 10 having a cover 12 and a bottom 14, having a number of rotationally driven friction elements 40 formed in container 10 and arranged on a first shaft 30. The longitudinal axis of first shaft 30 is oriented substantially, preferably precisely parallel to the longitudinal axis of container 10. On first shaft 30, a drive in the form of an electric motor 20 and a first bearing 22 are arranged on the upper side of shaft 30. A second bearing 25, spaced apart from first bearing 22, is arranged on the lower side of shaft 30, which goes through bottom 14. Second bearing 25 forms a force-locking connection with bottom 14. Both first bearing 22 and second bearing 25 each have a grease nipple 26. Friction elements 40 are arranged between first bearing 22 and second bearing 25 within container 10. Container 10 has a first flange 42 on the upper side and a second flange 44 on the lower side, whereby first flange 42 is force-locked to cover 12 and second flange 44 is force-locked to bottom 14.

Container 10 has two seats 50 for temperature sensors. Seats 50 each have slots in the container wall, so that the temperature sensors measure the temperature within the container. Container 10 also has a first opening 60, which is formed as a filling device, and a second opening 70, which is formed as an outlet device, and a third opening 80, which is formed as an exhaust device or an exhaust opening. First opening 60, second opening 70, and third opening 80 have a connector-shaped formation on the outside of container 10. Automatic shutoff devices 110 are provided both at first opening 60 and second opening 70.

Cover 12 is force-locked by means of a first screw connection 82 with first flange 42 and bottom 14 by means of a second screw connection 84 with second flange 14 and in each case are easily removable. Furthermore, first bearing 22 is flanged-mounted on cover 12. First bearing 22 is covered with a sleeve. The sleeve is connected on the bottom side with a third screw connection 86 to cover 12 and on the top side by means of a fourth screw connection 88 to the electric motor. A frequency converter 100 is provided to monitor the speed of shaft 30. A suction device can be attached to the exhaust opening to generate a slight negative pressure in container 10 and to withdraw the accumulating dust by suction. Because first opening 60 and second opening 70 are not made air-tight, air flows through both openings 60, 70.

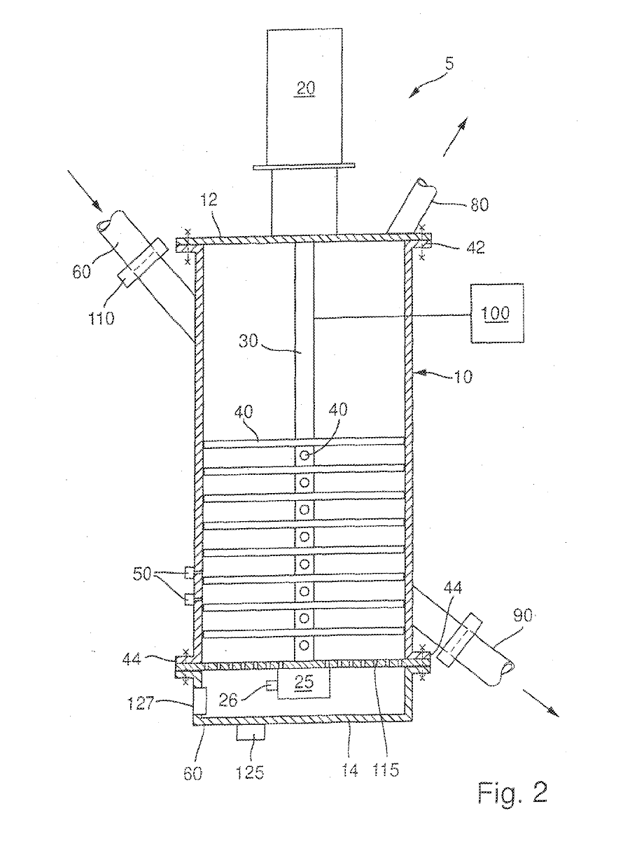

Another embodiment of regeneration device 5 is shown in the illustration of FIG. 2. Only the differences in regard to the embodiment in FIG. 1 will be explained below. Some details of the design in FIG. 1 are not shown for reasons of clarity. Bottom 14 is formed as a distribution chamber, whereby the distribution chamber is separated off from container 10 by means of a distribution plate 115, and fourth opening 125 is formed on the bottom side of bottom 14 as an air intake opening or air intake device on the distribution chamber. The distribution chamber furthermore has an inspection opening 127 for lubricating second bearing 25. Distribution plate 115 has a plurality of holes through which the supplied air flows. In this way, the sand is additionally kept suspended during the regeneration.

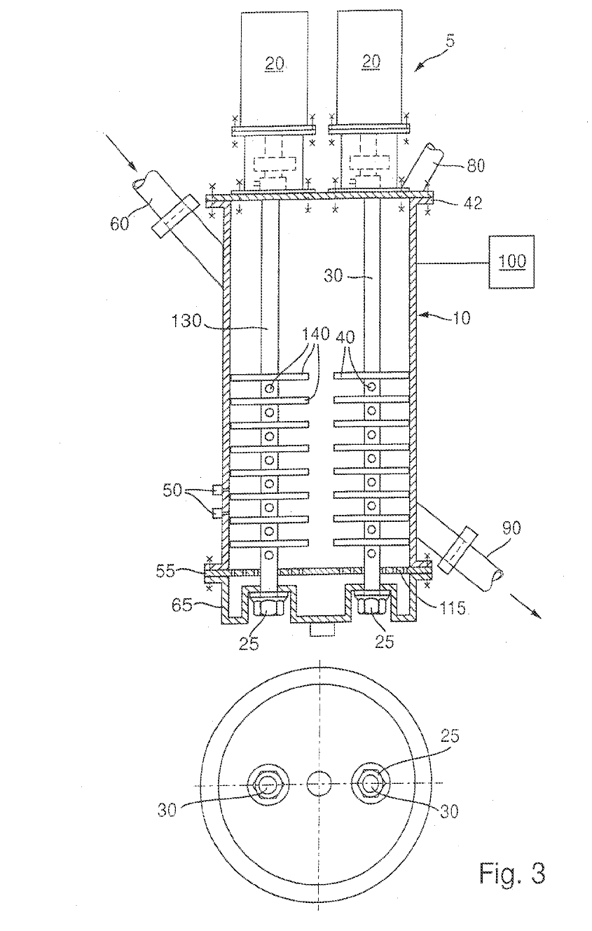

Another embodiment of regeneration device 5 is shown in the illustration of FIG. 3. Only the differences to the embodiment of FIG. 1 or of FIG. 2 will be explained hereafter. Some details of the design in FIG. 1 or FIG. 2 are not shown for reasons of clarity. In this case, a second shaft 130 with second friction bars 140 is provided. Bottom 14 now has a first recess, whereby the first recess receives second bearings 25, so that second bearings 25 are arranged outside the outer side of the housing. Furthermore, a deflecting bar (not shown) is provided on the inner side of container 10.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A regeneration device for reclaiming used foundry sand, the device comprising:
a cylindrical container having a cover and a bottom;
a first opening and/or a second opening;
a plurality of rotationally driven friction elements formed in the container, the friction elements being arranged on a first shaft;
a first bearing arranged on the first shaft;
a second bearing arranged on the first shaft that is spaced apart from the first bearing, the friction elements being arranged between the first bearing and the second bearing, and
wherein the container has a first flange on an upper side and a second flange on a lower side, and
wherein the first flange is force-locked to the cover and the second flange is force-locked to the bottom.

2. The regeneration device according to claim 1, wherein the cover is connected via a first screw connection to the first flange and wherein the bottom is connected via a second screw connection to the second flange.

3. The regeneration device according to claim 1, wherein the first opening is formed as a filling device and/or as an exhaust opening and wherein the second opening is formed as an outlet device and/or as an air intake opening.

4. The regeneration device according to claim 1, further comprising a third opening spaced apart from the first opening and formed as an exhaust device, and/or a fourth exhaust opening spaced apart from the second opening and formed as an air intake device.

5. The regeneration device according to claim 1, wherein the bottom is formed as a distribution chamber, wherein the distribution chamber is separated off from the container via a distribution plate, and wherein the fourth opening is formed on the distribution chamber.

6. The regeneration device according to claim 1, wherein the fourth opening is formed on an underside of the bottom.

7. The regeneration device according to claim 1, wherein the first opening and the second opening are formed on the container and have a connector-shaped formation on the outside of the container.

8. The regeneration device according to claim 1, wherein a temperature sensor is arranged on the container.

9. The regeneration device according to claim 1, wherein the second bearing forms a force-locking connection with the bottom.

10. The regeneration device according to claim 1, wherein the bottom has a first recess and the first recess receives the second bearing so that the second bearing is arranged outside the outer side of the housing.

11. The regeneration device according to claim 1, wherein the shaft is oriented parallel to a longitudinal axis of the cylinder.

12. The regeneration device according to claim 1, wherein a second shaft is provided with second friction bars.

13. The regeneration device according to claim 12, wherein a deflecting bar is arranged on an inner side of the container.

14. The regeneration device according to claim 1, wherein the bearings have a grease nipple.
